(19) United States
(12) Patent Application Publication
(10) Pub. No.: US 2015/0199696 A1
(43) Pub. Date: Jul. 16, 2015

(54) RFID Item Interest Determination System

(71) Applicant: Thinkify, LLC, Morgan Hill, CA (US)

(72) Inventor: Curtis L. Carrender, Morgan Hill, CA (US)

(73) Assignee: Thinkify, LLC

(21) Appl. No.: 14/592,530

(22) Filed: Jan. 8, 2015

Related U.S. Application Data
(60) Provisional application No. 61/925,822, filed on Jan. 10, 2014.

(51) Int. Cl. G06Q 30/02; G06K 7/10

(52) U.S. Cl. CPC G06Q 30/0201; G06K 7/10366

(57) ABSTRACT

A signal is received from each of a first RFID tag corresponding to a first item and a second RFID tag corresponding to a second item. It is determined that the first item was purchased from the retail environment. A relative movement of the second item to the first item within the retail environment is determined. An item interest in the second item relative to the first item is determined based on the relative movement. A purchase analysis of the second item relative to the first item based on the item interest is provided.

### CROSS REFERENCE TO RELATED APPLICATIONS

I hereby claim benefit under Title 35, United States Code, Section 119(e) of U.S. provisional patent application Ser. No. 61/925,822 filed Jan. 10, 2014. The 61/925,822 application is currently pending. The 61/925,822 application is hereby incorporated by reference into this application.

### BACKGROUND OF THE INVENTION

In retail stores, the primary measure of whether consumers prefer one product relative to another is which product the consumers purchase. By comparing the sales volume, a retail store may determine that consumers preferred product A over product B. RFID systems are used to track the inventory when sales are made, so that the retail store knows when to reorder products whose inventories may be running low. While this information may be useful in managing products that sell, it does not currently provide additional consumer interaction with the product in the store such as how interesting the product appeared, why a product was not purchased, or how to increase the sales the those products that were not purchased.

### BRIEF SUMMARY OF THE INVENTION

A signal is received from each of a first RFID tag corresponding to a first item and a second RFID tag corresponding to a second item. It is determined that the first item was purchased from the retail environment. A relative movement of the second item to the first item within the retail environment is determined. An item interest in the second item relative to the first item is determined based on the relative movement. A purchase analysis of the second item relative to the first item based on the item interest is provided. In those cases where neither item is purchased, a relative interest data point is generated based on each item, the location of each item, the presentation of each item, or other attributes of each item and its environment.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a block diagram of a RFID Item Interest Determination System (RIIDS), according to an example embodiment.

FIG. 2 is an example of a standard display for a retail store.

FIG. 3 is an example of a display for a retail environment using RIIDs, according to an embodiment.

FIG. 4 is an example of different queries that may be answered by purchase analysis of RIIDS, according to an embodiment.

FIG. 5 is an example of sales velocity data that may be provided by RIIDS, according to an embodiment.

FIG. 6 is an example of item movement data that may be provided by RIIDS, according to an embodiment.

FIG. 7 is an example of a purchase analysis 19 that may be provided by RIDDS 10, according to an embodiment.

FIG. 8 shows example readings from a RFID reader, according to an embodiment.

FIG. 9 is a flowchart illustrating an example process of RIIDS, according to an embodiment.

FIG. 10 is a flowchart illustrating another example process of RIIDS, according to an embodiment.

### DETAILED DESCRIPTION OF THE INVENTION

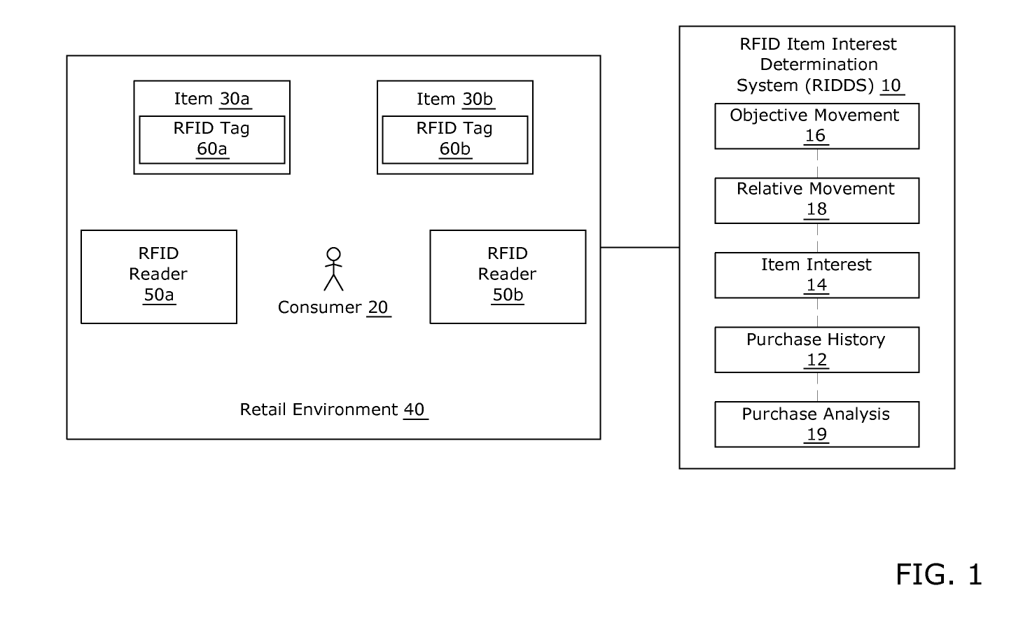

FIG. 1 is a block diagram of a RFID Item Interest Determination System (RIIDS) 10, according to an example embodiment. RFID tags 60 are radio-frequency identifier tags that can be affixed to items 30 and used to track the movement of those items 30 by being read by one or more RFID readers 50. Companies can use RFID item tracking for asset tracking and inventory control. For example, RFID tags 60 may be used to replace more traditional barcodes and enable self-service checkout by patrons. When an item 30A is purchased in a retail environment 40, the RFID tag 60A may be read by a RFID reader 50 at the register, and a sales and/or inventory system may be updated to reflect the time, date, quantity, and price of the purchase. Alternatively, a standard barcode or manual system may be used to process or indicate the sale of the item 30.

An RFID system, such RIIDS 10, may use RFID readers 50 that can read signals from multiple RFID tags 60 (e.g., as opposed to barcodes which are read one at a time) that may be affixed to or otherwise integrated with items 30. Items 30 may be any items 30 may be any items for sale within retail environment 40 that may be accessible to consumers 20. Example items 30 include clothing, jewelry, firearms, cologne, shoes, electronics, and sunglasses.

There are three main types of RFID technology that may be used in the present invention: active, semi-passive and passive. Active RFID tags utilize a battery to broadcast radio waves containing data. Semi-passive RFID tags utilize a smaller battery than active RFID tags to keep the RFID tag “awake” but still rely upon a reader to provide power for broadcasting radio waves. Passive RFID tags are completely reliant upon an external RFID reader to provide the power to broadcast radio waves containing the data. Active RFID tags can transmit radio waves that may be read at ranges of 300 feet or more. Passive RFID tags can transmit radio waves that may be read at ranges of 20 or more feet. Passive RFID tags are the most common RFID tag because of they are relatively inexpensive compared to active and semi-passive RFID tags.

Passive RFID tag systems have two main components: an RFID reader and an RFID tag. The RFID reader has a reader antenna that transmits radio waves that are received by an RFID antenna within the passive RFID tag. The radio waves received by the passive RFID tag are converted to electrical power and then used by the RFID tag to transmit radio waves containing data that are then detected by the RFID reader. The RFID reader then communicates the data received from the RFID tag via the radio waves to another device (e.g. computer) for processing.

Based on signals received by one or more RFID readers 50 from within retail environment 40, RIIDS 10 may determine an objective movement 16 of each RFID tag 60 (and corresponding item 30) through retail environment 40. In an embodiment, a RFID reader 50 may ping RFID tag 60 and record the return signal. In another embodiment, RFID tag 60 may transmit its own signal without first being prompted by a signal from a RFID reader 50.

Objective movement 16 indicates a movement of an individual RFID tag 60A, 60B through retail environment 40 as determined by RFID readers 50 placed within retail environment 40. Objective movement 16 may indicate the time of movement, the rate or velocity of movement, where within retail environment the RFID tag 60 (and corresponding item 30) was moved, and time of purchase or final movement. In an embodiment, objective movement 16 (as determined from RFID tag 60A) may indicate from where item 30A was picked up by consumer 20 and where item 30A traveled through retail environment 40.

Objective movement 16 may indicate a motion of item 30A while being handled by consumer 20. In an embodiment, RFID reader 50 may include two or more channels over which to read signals from RFID tags 60. For example, RFID reader 50 may be able to determine phase rotation and direction of the phase signal. Based on the phase rotation of the signal, RFID reader 50 may determine how item 30A was handled by consumer 20. For example, RFID reader 50 may determine that consumer 20 pickup and rotated or otherwise moved or inspected item 30A from shelf 1 (not pictured) in retail environment 40 before being placed back down onto shelf 1 or another shelf. This consumer inspection information as well as other movement information corresponding to RFID tag 60 may be received by RIIDS 10 as objective movement 16.

Retail environment 40 may be a retail store or other location in which consumers 20 or patrons may enter and handle items 30 which may be displayed or otherwise for sale. Retail environment 40 may be, for example, a grocery store, jewelry store, department store, electronics store, furniture store, or any other retail outlet. And consumer 20 may be any patron entering retail environment 40 who handles items 30. FIG. 1 is an exemplary embodiment, with a single retail environment 40 with a single consumer 20, however in other embodiments, the applications of RIIDS 10 may be applied across multiple retail environments 40 and/or consumers 20.

Based upon objective movement information 16, RIIDS 10 may determine an item interest 14 for items 30. Item interest 14 may be a measure of consumer 20 interest in item 30A based upon its objective movement 16. Items interest 14 may be determined for a single consumer 20 or aggregated across multiple consumers 20. In an embodiment, RIIDS 10 may determine that the objective movement 16 (or a factor thereof, such as velocity or speed) associated with RFID tag 60A, the greater a consumer's item interest 14 in item 30A.

In an embodiment, in determining item interest 14, RIIDS may compare objective movement 16 for item 30 against a baseline, average, or aggregate objective movement 16. For example, a tracking history of item 30A may indicate that consumers 20 who purchased item 30A (as determined from a purchase history 12) moved item 30A an average of 40 meters through retail environment 40. Or, for example, the tracking history of item 30A may indicate that item 30A was usually rotated 180 degrees prior to purchase. RIIDS 10 may compare objective movement 16 to the baseline or tracking history of item 30A to determine a level of interest. For example, if 40 meters was the average objective movement 16 of item 30A prior to purchase, then an objective movement of 20 meters may indicate a low level of item interest 14, while an objective movement of 60 meters may indicate a high level of item interest 14. In an embodiment, item interest 14 may be measured on a scale, such as 1-10, 10 indicating a highest level of a consumer's 20 interest in item 30A.

As described herein, all measurements and determinations associated with one item 30 may also performed across multiple items 30, retail environments 40, consumers 20, and time periods. In addition to being able to determine objective movement 16 and item interest 14 for a particular item 30A, RIIDS10 may also determine a relative movement 18 and item interest 14 of item 30A relative to one or more other items 30B.

Relative movement 18 is a measure of the movement of item 30A relative to one or more other items 30B. In an embodiment, items 30A and 30B may be associated with one another. Items 30A and 30B may be competitors, alternatives, or complimentary items. For example, items 30A and 30B may be an electronic toy and batteries for the toy (complimentary), two different brands of shampoo (competitors), or liquid soap and bar soap (alternatives). In an embodiment, items 30A and 30B may be items spatially located near each other, such as clearance items.

Relative movement 18 may be a measure of the movement of item 30A relative to item 30B. For example, relative movement 18 may indicate that item 30B is moved 30 meters through retail environment 40 while item 30A is only moved 1 meter. Then, for example, based on relative movement 18, RIIDs 10 may determine a low level of item interest 14 of item 30A relative to item 30B.

RIIDS 10 may also receive or have access to purchase history 12. Purchase history 12 may indicate which items 30 were purchased, the sales price, when they were purchased, and which other items 30 may be have been part of the same purchase.

Based on relative movement 18, item interest 14, and purchase history 12, RIIDS 10 may determine or provide a purchase analysis 16. Purchase analysis 16 may be a determination as to what caused consumer 20 to purchase one item 30 over another based on the movement (objective and/or relative) of the items 30 within retail environment 40.

For example, relative movement 18 and purchase history 12 may indicate that consumers 20 picked up and rotated item 30A before picking up, moving, and purchasing item 30B. Based on this relative movement 18, RIIDS 10 may determine that branding, placement, or marketing of item 30A may be superior to that of item B, but that there is something on the packaging of item 30A that turns consumer 20 away from purchasing item 30A. This purchase analysis 16, may then be used to improve the packaging of item 30A and/or branding or marketing of item 30B to improve sales of either or both items 30.

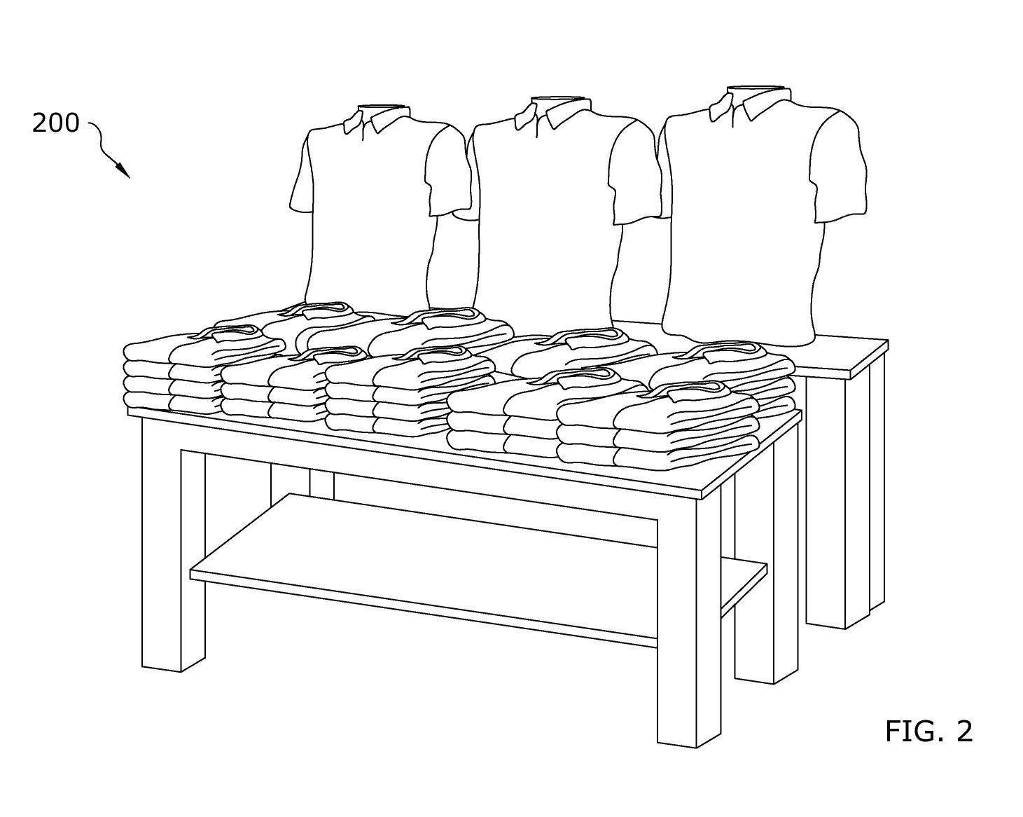

FIG. 2 is an example of a standard display 200 for a retail store. In the example of FIG. 2, a single product, such as shirt, is displayed in a retail store. Without the use of RIIDS 10, the retail store may look at a sales history to determine that white short-sleeve shirts sell the best. As such, the focus of the display 200 is on a single product. If sales for the product drop, the retail store may put a new product into the display 200. The retail store however would not have any additional business intelligence, such as movement and/or consumer interest information as provided by RIIDS 10.

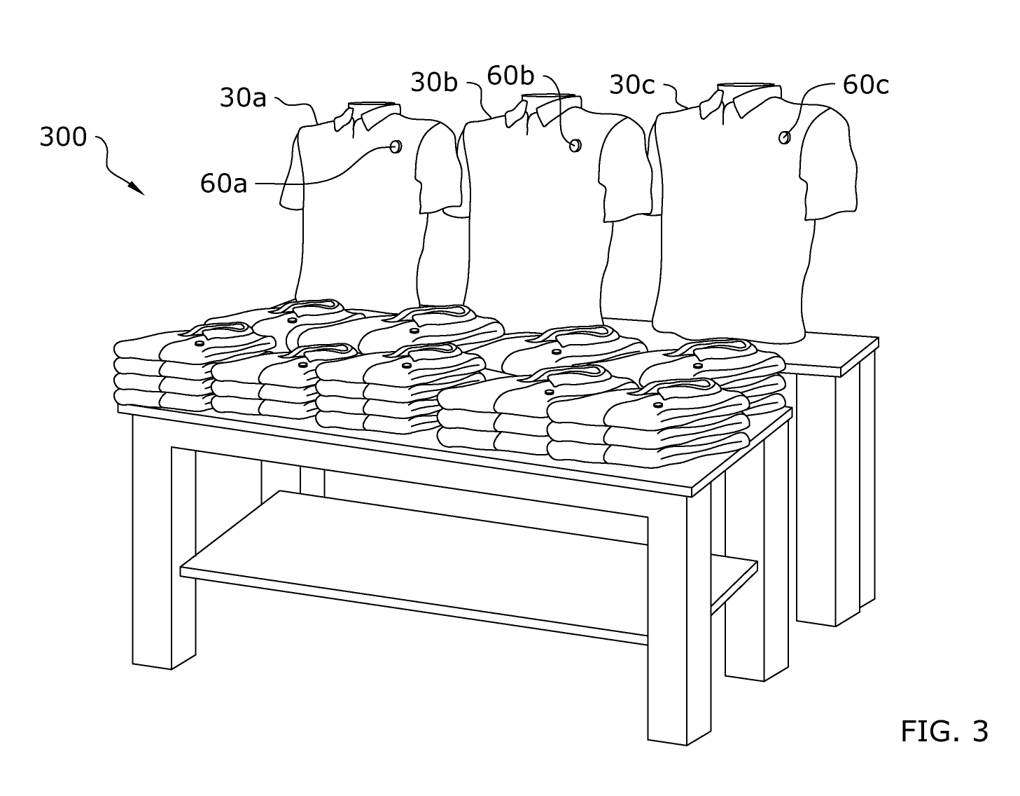

FIG. 3 is an example of a display 300 for a retail environment 40 using RIIDs, according to an embodiment. In the example of FIG. 3, a single item 30, such as shirt, is displayed in a retail store. However, the item 30 may be displayed with variations in size and/or color, with unique RFID tags 60 on each size, color, and/or style combination. In the example, items 30A, 30B, and 30C may be shirts of different colors. RIIDS 10 may then track the movement of those items 30 and determine the item interest 14 in each tagged item 30A-30C.

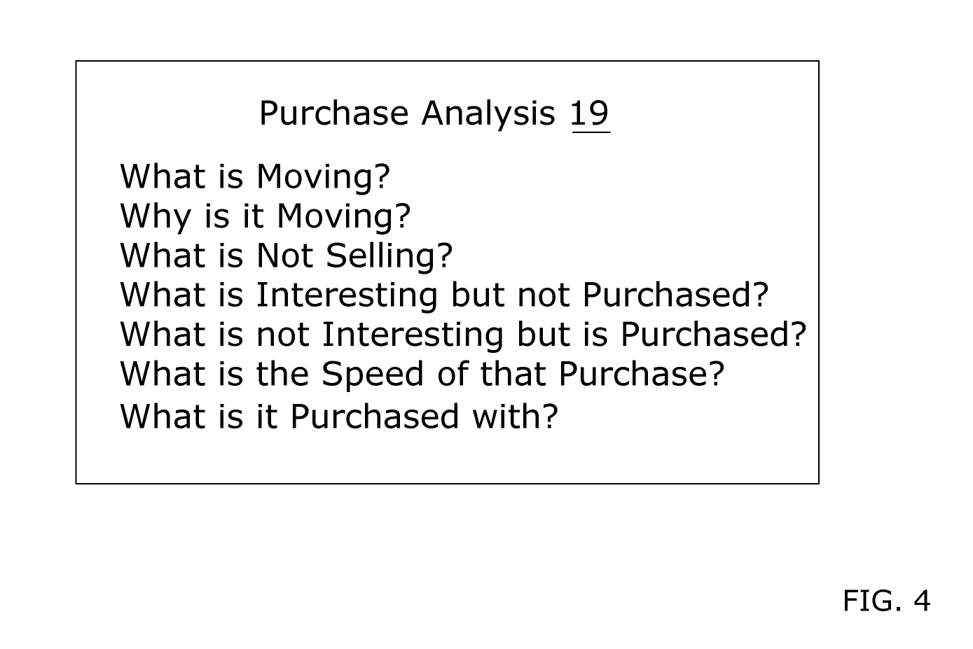

FIG. 4 is an example of different queries that may be answered by purchase analysis 16 of RIIDS 10, according to an embodiment. RIIDS 10 may track objective movement 16 of items 30 throughout retail environment 40, relative movement 18 of items 30 to each other, to determine an item interest 14 for the items 30.

RIIDS 10 may then compare item interest 14 to purchase history 12 to develop purchase analysis 19. Purchase analysis 12 is any determination that may be made as to why a consumer purchased/did not purchase one or more items 30. RIIDS 10 may provide purchase analysis 19 to a retailer and/or manufacturer of items 30 to help improve sales. Example queries that may be answered through purchase analysis 12 are shown in FIG. 4.

The purchase analysis 19 for “what is moving?” may indicate which items 30 are being picked up and moved around retail environment 40. RIIDS 10 may answer this query, for example, based on objective movement 16.

The purchase analysis 19 for “why is it moving?” may indicate why items 30 are being picked up and moved around retail environment 40. RIIDS 10 may answer this query, for example, based on objective movement 16 and relative movement 18.

The purchase analysis 19 for “what is not selling?” may indicate which items 30 are not being purchased. RIIDS 10 may answer this query, for example, based on purchase history 12.

The purchase analysis 19 for “what is interesting but not purchased?” may indicate which items 30 are being picked up and moved around retail environment 40 but not purchased. RIIDS 10 may answer this query, for example, based on objective movement 16 and purchase history 12.

The purchase analysis 19 for “what is not interesting but is purchased?” may indicate which items 30 are not being moved around retail environment 40 much, but are still being purchased. RIIDS 10 may answer this query, for example, based on objective movement 16 and purchase history 12.

The purchase analysis 19 for “what is speed of purchase?” may indicate what is the time differential between when an item 30 is picked up and when it is purchased. RIIDS 10 may answer this query, for example, based on objective movement 16 and purchase history 12.

The purchase analysis 19 for “what is it being purchased with?” may indicate which items 30 are being purchased together. RIIDS 10 may answer this query, for example, based on purchase history 12.

Any purchase analysis 19 may be provided objectively with regard to a selected item 30A, or relative to one or more additional items 30B. Further, several different purchase analysis 19 may be combined to provide new or additional purchase analysis 19.

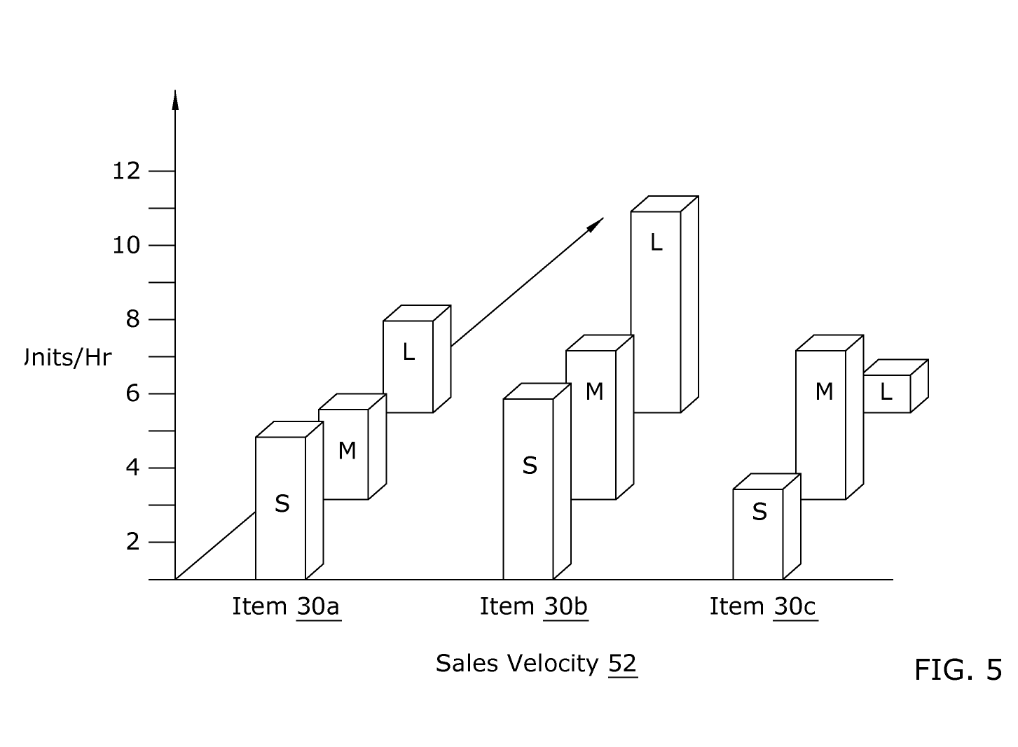

FIG. 5 is an example of sales velocity data 52 that may be provided by RIIDS 10, according to an embodiment. Sales velocity data 52 may be the purchase analysis 19 for the query “what is the rate of purchase?” For example, based on purchase history 12, RIIDS 10 may determine how many items 30A-30C were purchased over a particular time period, and further break those purchases down by size. In an embodiment, RFID tags 60 for similar items 30 may register in RIIDS 10 as being the same. For example, two shirts of the same color and same size may have similar RFID tag identifiers. This information may be based on RFID tags 60 being read at a register or other point of sales within retail environment 40. In the example shown, item 30B, in size large (L) may have sold, on average, 10 units/hour over the specified time period, which is more than any other size/color combination item 30.

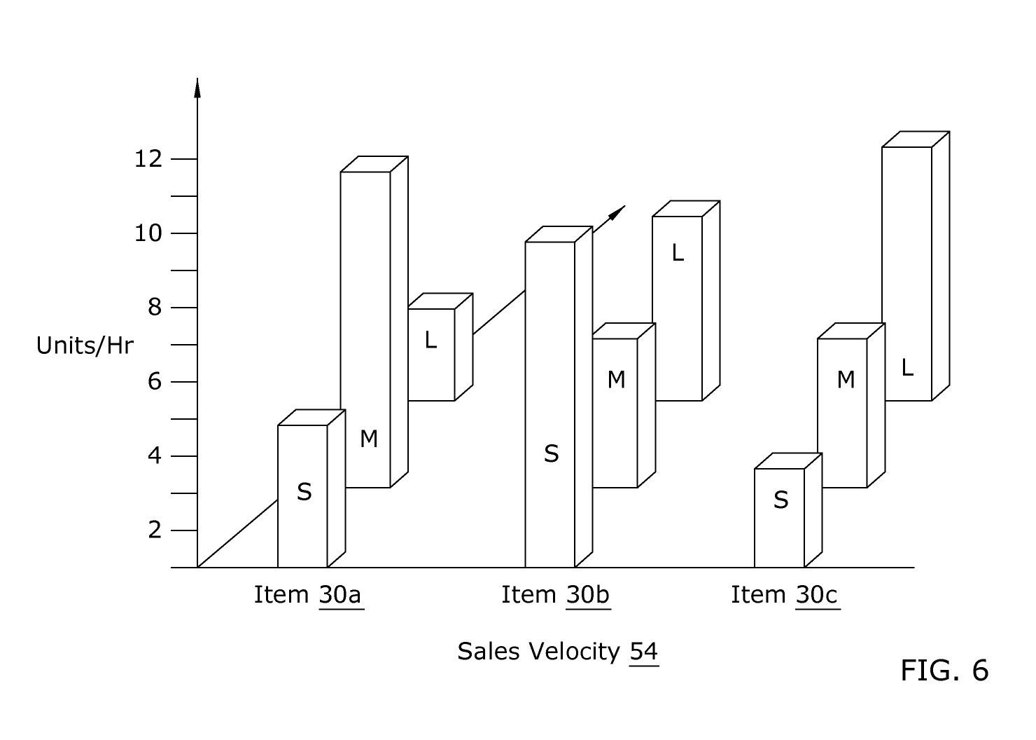

FIG. 6 is an example of item movement data 54 that may be provided by RIIDS 10, according to an embodiment. Item movement data 54 may provide information for both objective movement 16 and relative movement 18 of items 30.

FIG. 6 shows the number of units being moved per hour, which may be done over the same time period as the data provided in FIG. 5. In the item movement data 54 shown, the medium size of item 30A, small size of item 30B, and large size of item 30 C may be the most moved (e.g., objective movement 16) per hour, for each item 30. The movement data 54 however shows relative movement 18 for other associated and tracked items 30 (e.g., shirts of the same color but different size, and shirts of the same size but different color).

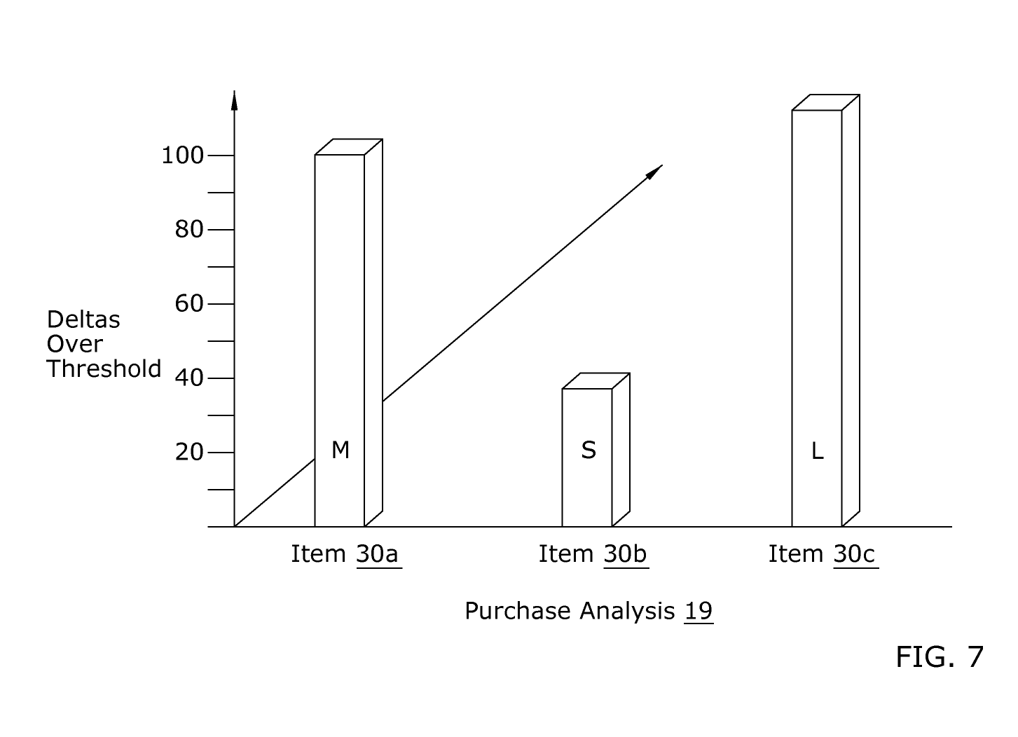

In another embodiment, item movement 54 may indicate the average distance and/or speed each item 30A-C is moved throughout retail environment 40. FIG. 7 is an example of a purchase analysis 19 that may be provided by RIDDS 10, according to an embodiment. Purchase analysis 19 may indicate those items 30 with the greatest variation between how much they are being moved or the level item interest 14 in the items 30 and how often they are being purchased (as determined from purchase history 12). RIDDS 10 may be perform a comparative analysis and produce purchase analysis 19 as shown in FIG. 7.

Based on purchase analysis 19, RIDDS 19 may suggest or determine, for example, that there is a defect with medium shirts of item 30A that consumers 20 find when they move or inspect the item 30A, which may cause them not to purchase it. Or, it may be determined from purchase analysis 19 that the color of item 30C actually slightly changes when the large shirts of item 30C are produced, causing consumers 20 to not purchase the shirts 30C upon inspection.

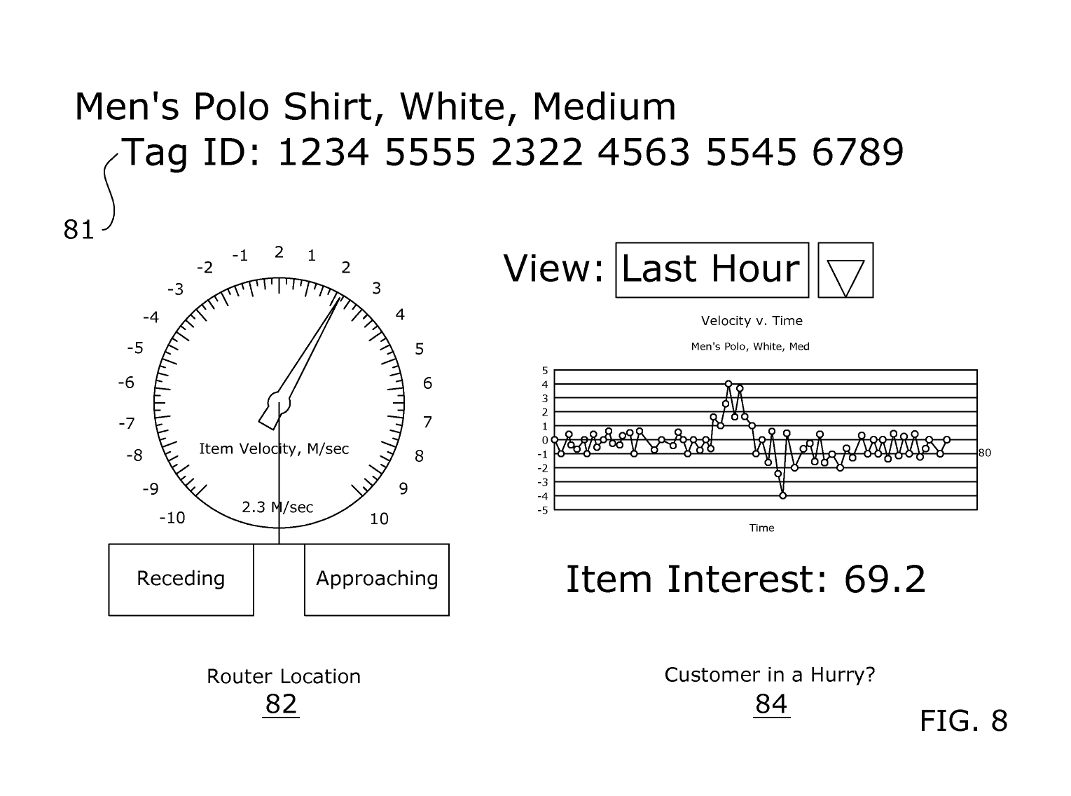

FIG. 8 shows example readings from a RFID reader 50, according to an embodiment. RFID readers 50 may read RFID tags 60 from items 30 that are being moved throughout retail environment 40. Retail environment 40 may have multiple RFID readers 50 placed throughout.

From RFID tag 60, an RFID reader 50 may determine item information 81. Item information 81 may include, a Tag ID and a description of the product. In an embodiment, the description associated with the Tag ID may be retrieved from or otherwise stored in a database of RIIDS 10 in communication with RFID reader 50. Alternatively, the information on this description may reside in the data of the RFID tag 60 itself. As noted above, each item variation (e.g., style, size, and/or color combination) may have its own RFID. In the example of FIG. 8, the Tag ID may correspond to all men's polo shirts (of a particular style), that are white, and medium sized.

In an embodiment, RFID reader 50 may track an item velocity 82 relative to the RFID reader 50. For example, as shown, a currently tracked item 30 may be approaching the reader 50 at a speed of 2.3 meters/second. A second RFID reader 50 may be tracking the same item as receding from it at 2.3 meters/second. While the item 30 may be out of the range of a third reader 50.

In an embodiment, RFID reader 50 may track or otherwise provide the velocity information to RIIDS 10 that may determine with what velocity the item has been moving over a period of time as shown in display 84. Display 84 may show each interaction or movement with the item 30 over the last hour and the determined velocity associated with that movement. As shown, the positive numbers may indicate that the RIFD tag 60 was tracked as approaching the RFID reader 50, while the negative numbers may indicate a velocity movement away from the RFID reader 50.

Display 84 also includes a customer engagement score of 69.2. According to an embodiment, the item interest or customer engagement score may indicate the average number of times the item was moved per hour.

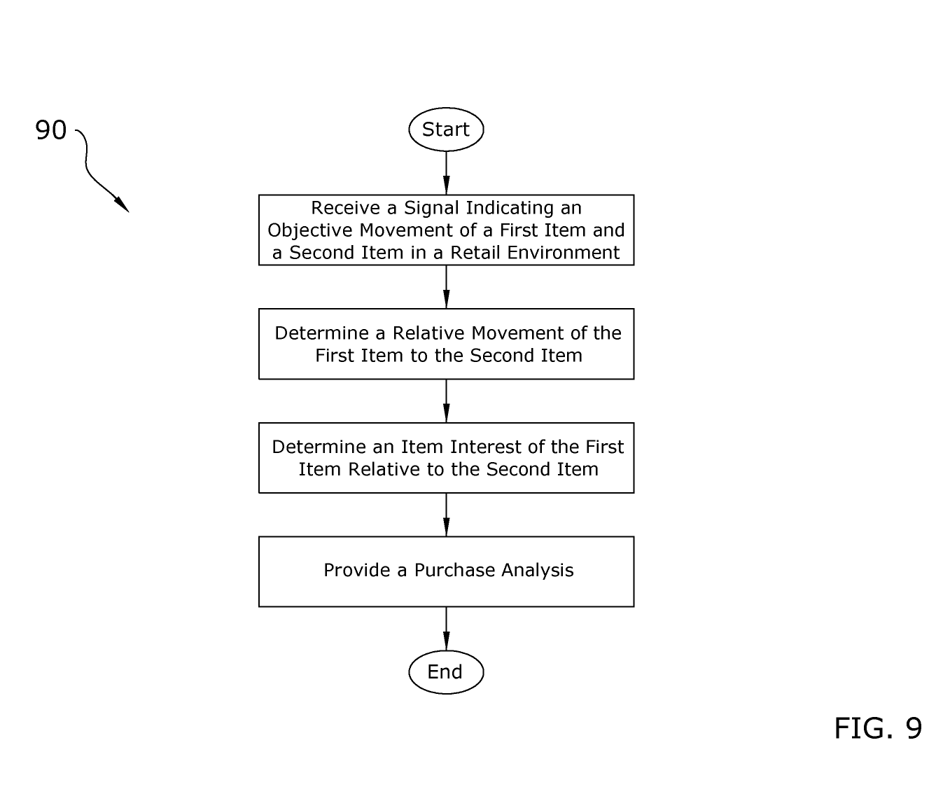

FIG. 9 is a flowchart illustrating an example process 90 of RIIDS, according to an embodiment. As shown in FIG. 9, a signal may be received indicating an objective movement of a first item and a second item in a retail environment. For example, RIIDS 10 may receive objective movement 16 of both first item 30A and second item 30B, from RFID reader 50A and 50B. The readers 50 may be able to read signal from either or both RFID tags 60 attached to the items 30.

A relative movement of the first item relative to the second item is determined. For example, RIIDS 10 may perform a comparative analysis on the objective movement 16 of item 30A to the objective movement 16 of item 30B to determine a relative movement 18 between the items.

An item interest of the first item relative to the second item is determined. For example, based on the relative movement 18, it may be determine in which item 30A or 30B a consumer 20 indicated more interest (e.g., by greater movement).

A purchase analysis is provided. For example, the item interest 14 may be compared against the purchase history 12 to determine any patterns or correspondence between item interest 14 and item purchases.

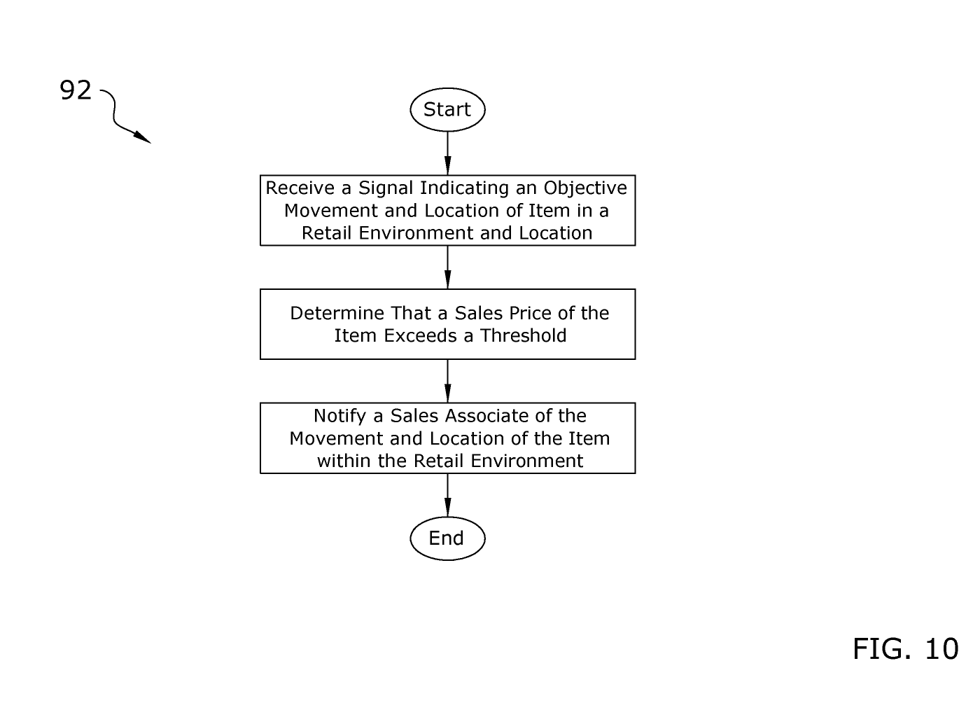

FIG. 10 is a flowchart illustrating another example process 92 of RIIDS, according to an embodiment. RIDDS 10 may receive a signal indicating an objective movement 16 and location of an item 30 in a retail environment 40. For example, one or more of the RFID readers 50 may determine that the velocity of RFID tag 60A went from 0 to a value greater than or less than zero, indicating that the item 30A is being moved from its resting position (e.g., shelf or display). Objective movement 16 may indicate an approximate location of RFID tag 60A, of where the movement occurred (e.g., relative to RFID reader 50).

RIIDS 10 may determine that a sales price of the item 30A exceeds a threshold. For example, upon receipt of the movement information (indicating item 30 is being moved from its display), RIIDS 10 may check the Tag ID against purchase history 12 or other sales data indicating a sales price of item 30A. The sales prices is then checked against a price threshold to determine whether or not the item 30 is considered an expensive item, luxury good, or other item that may require sales associate assistance. In another embodiment, RIIDS 10 may include a list of Tag IDs for which associate assistance may be required.

RIIDS 10 may then notify a sales associate of the movement and location of the item 30 within the retail environment 40. The sales associate may be able to aid the customer 20 with any questions or assistance in purchasing a luxury item, and may also serve as a deterrent against shoplifting the item 30 by consumer 20.

In another embodiment, if it is after business hours and the retail environment 40 is closed, upon detecting the movement of an item 30, RIIDS 10 may contact a security company or other emergency personnel to indicate item movement after business hours (which may be indicative of a crime).

Any and all headings are for convenience only and have no limiting effect. Unless otherwise defined, all technical and scientific terms used herein have the same meaning as commonly understood by one of ordinary skill in the art to which this invention belongs. Although specific terms are employed herein, they are used in a generic and descriptive sense only and not for purposes of limitation. All publications, patent applications, patents, and other references mentioned herein are incorporated by reference in their entirety to the extent allowed by applicable law and regulations.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs), DVDs (digital video discs), and computer instruction signals embodied in a transmission medium (with or without a carrier wave upon which the signals are modulated). For example, the transmission medium may include a telecommunications network, such as the Internet.

The present invention may be utilized upon any telecommunications network capable of transmitting data including voice data and other types of electronic data. Examples of suitable telecommunications networks for the present invention include but are not limited to global computer networks (e.g. Internet), wireless networks, cellular networks, satellite communications networks, cable communication networks (via a cable modem), microwave communications network, local area networks (LAN), wide area networks (WAN), campus area networks (CAN), metropolitan-area networks (MAN), and home area networks (HAN). The present invention may communicate via a single telecommunications network or multiple telecommunications networks concurrently. Various protocols may be utilized by the electronic devices for communications such as but not limited to HTTP, SMTP, FTP and WAP (wireless Application Protocol). The present invention may be implemented upon various wireless networks such as but not limited to 3G, 4G, LTE, CDPD, CDMA, GSM, PDC, PHS, TDMA, FLEX, REFLEX, IDEN, TETRA, DECT, DATATAC, and MOBITEX. The present invention may also be utilized with online services and Internet service providers.

The Internet is an exemplary telecommunications network for the present invention. The Internet is comprised of a global computer network having a plurality of computer systems around the world that are in communication with one another. Via the Internet, the computer systems are able to transmit various types of data between one another. The communications between the computer systems may be accomplished via various methods such as but not limited to wireless, Ethernet, cable, direct connection, telephone lines, and satellite.

The central communication unit (such as RIIDS 10) may be comprised of any central communication site where communications are preferably established with. The central communication units may be comprised of a server computer, cloud based computer, virtual computer, home computer or other computer system capable of receiving and transmitting data via IP networks and the telecommunication networks. As can be appreciated, a modem or other communication device may be required between each of the central communication units and the corresponding telecommunication networks. The central communication unit may be comprised of any electronic system capable of receiving and transmitting information (e.g. voice data, computer data, etc.).

The invention is described above with reference to block and flow diagrams of systems, methods, apparatuses, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention. These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks. Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

The present invention may be embodied in other specific forms without departing from the spirit or essential attributes thereof, and it is therefore desired that the present embodiment be considered in all respects as illustrative and not restrictive. Many modifications and other embodiments of the invention will come to mind to one skilled in the art to which this invention pertains and having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although methods and materials similar to or equivalent to those described herein can be used in the practice or testing of the present invention, suitable methods and materials are described above. Thus, the present invention is not intended to be limited to the embodiments shown, but is to be accorded the widest scope consistent with the principles and features disclosed herein.

1. A method, comprising:
receiving a signal from each of a first RFID tag corresponding to a first item and a second RFID tag corresponding to a second item, wherein each signal indicates an objective movement of the respective item within a retail environment, wherein the second item is associated with the first item;
determining that the first item was purchased from the retail environment;
determining a relative movement of the second item to the first item within the retail environment;
determining an item interest in the second item relative to the first item based on the relative movement, wherein a greater relative movement of the first item to the second item corresponds to a greater interest in the first item; and
providing a purchase analysis of the second item relative to the first item based on the item interest, the purchase of the first item, and the objective movement of the second item.

2. The method of claim 1, wherein the objective movement is from a first location in the retail location to a second location in the retail environment.

3. The method of claim 2, wherein the second location is the first location and the second item was returned to the first location.

4. The method of claim 1, wherein the signal indicates a phase and a phase rotation of the respective RFID tag.

5. The method of claim 1, wherein the first item and second item are competitors, wherein both the first and second item perform a similar function.

6. The method of claim 1, wherein the first item and second item are complimentary, wherein a use of the second item is complimentary to the a user of the first item.

7. The method of claim 1, wherein the first item and second item are spatially located in a similar location within the retail environment.

8. The method of claim 1, further comprising:
providing a purchase analysis of the first item.

9. The method of claim 1, wherein the objective movement comprises a speed of purchase indicating a first time between when the first item was moved from a first location to a second time when the first item was purchased.

10. The method of claim 1, further comprising:
determining that a sales price of either the first item or the second item exceeds a threshold; and
notifying a sales associate of a location of the respective RFID tag associated with the item that exceeds the threshold upon a receipt of the signal from either the first RFID tag or the second RFID tag.

11. A system comprising: one or more processors coupled to a non-transitory memory, that when executed perform the following:
receiving a signal from each of a first RFID tag corresponding to a first item and a second RFID tag corresponding to a second item, wherein each signal indicates an objective movement of the respective item within a retail environment, wherein the second item is associated with the first item;
determining that the first item was purchased from the retail environment;
determining a relative movement of the second item to the first item within the retail environment;
determining an item interest in the second item relative to the first item based on the relative movement, wherein a greater relative movement of the first item to the second item corresponds to a greater interest in the first item; and
providing a purchase analysis of the second item relative to the first item based on the item interest, the purchase of the first item, and the objective movement of the second item.

12. The system of claim 11, the objective movement is from a first location in the retail location to a second location in the retail environment.

13. The system of claim 12, wherein the second location is the first location and the second item was returned to the first location.

14. The system of claim 11, wherein the signal indicates a phase and a phase rotation of the respective RFID tag.

15. The system of claim 11, wherein the first item and second item are competitors, wherein both the first and second item perform a similar function.

16. The system of claim 11, wherein the first item and second item are complimentary, wherein a use of the second item is complimentary to the a user of the first item.

17-20. (canceled)

21. A method, comprising:
receiving a signal from a first RFID tag corresponding to an item, wherein each signal indicates an objective movement of the item within a retail environment;
determining a phase change for the signal;
determining a movement of the item within the retail environment based on the phase change; and
determining an item interest based on the movement of the item.

22. The method of claim 21, wherein the signal indicates a phase and a phase rotation of the respective RFID tag.

23. The method of claim 21, further comprising:
provide a purchase analysis of the item based on the movement of the item.

24. The method of claim 21, further comprising:
provide a purchase analysis of the item based on the item interest, a purchase of the item, and the movement of the item.
